(19) United States
(12) Patent Application Publication
(10) Pub. No.: US 2009/0303177 A1
(43) Pub. Date: Dec. 10, 2009

(54) ELECTRONIC DEVICE AND METHOD FOR SELECTING FUNCTIONS BASED ON ORIENTATIONS

(75) Inventors: CHENG-HAO CHOU, Tu-Cheng (TW); TE-YUAN KUNG, Tu-Cheng (TW); CHUNG-JEN LAN, Tu-Cheng (TW); BO-CHING LIN, Tu-Cheng (TW); MING-FENG TSAI, Tu-Cheng (TW); HAN-CHE WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/425,392

(22) Filed: Apr. 17, 2009

(30) Foreign Application Priority Data
Jun. 4, 2008 (CN) 200810301996.4

(51) Int. Cl. G09G 5/00

(52) U.S. Cl. 345/156

(57) ABSTRACT

The present invention provides an electronic device and a method for selecting functions based on orientations of the electronic device. The method includes: a) storing relationships between orientations and functions; b) fetching inductive signals based on the orientation of the electronic device; c) recognizing the current orientation according to the fetched signals; and d) if the orientation is altered, selecting a function corresponding to the altered orientation and displaying a corresponding interface.

### BACKGROUND

1. Technical Field

The disclosure relates to an electronic device and, more particularly, to an electronic device and a method for selecting functions based on orientations of the electronic device.

2. Description of the Related Art

Electronic devices, such as digital photo frames, mobile phones, and e-books, include a plurality of functions. However, as the number of functions increase, choosing a function becomes more complicated, such as pressing a button several times, touching a pad repetitively, and the like. Therefore, conventional electronic devices may waste a lot of time and be inconvenient to operate.

Accordingly, what is needed in the art is an electronic device and a method for selecting functions that overcomes the aforementioned deficiencies.

### BRIEF DESCRIPTION OF THE DRAWINGS

The components in the drawings are not necessarily drawn to scale, the emphasis instead being placed upon clearly illustrating the principles of the electronic device. Moreover, in the drawings, like reference numerals designate corresponding parts throughout the several views.

FIG. 1 is a block diagram of a hardware infrastructure of an electronic device in accordance with a first exemplary embodiment.

FIG. 2 is a distribution diagram of induction units of the electronic device of FIG. 1.

FIG. 3 is an example of a function interface of a first orientation of the electronic device of FIG. 1.

FIG. 4 is an example of a function interface of a second orientation of the electronic device of FIG. 1.

FIG. 5 is a block diagram of a hardware infrastructure of an electronic device in accordance with a second exemplary embodiment.

FIG. 6 is a flowchart of a method for selecting a function implemented by the electronic device of FIG. 5.

### DETAILED DESCRIPTION

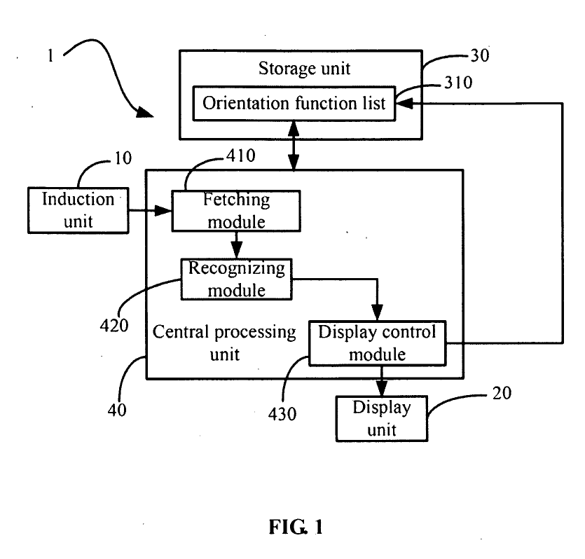

FIG. 1 is a block diagram of a hardware infrastructure of an electronic device in accordance with a first exemplary embodiment. The electronic device 1 may be a digital photo frame, a mobile phone, or an e-book, etc. The electronic device 1 includes at least one induction unit 10, a display unit 20, a storage unit 30, and a central processing unit 40. The induction unit 10 is configured for generating inductive signals. The induction unit 10 may be one of many kinds of inductors, such as a pressure inductor, a directional inductor, and the like. The display unit 20 is configured for displaying a function interface.

The storage unit 30 is configured for storing an orientation function list 310. The orientation function list 310 is provided to store relationships between orientations of the electronic device 1 and functions to be executed by the electronic device 1. The orientation function list 310 includes an orientation column and a function column. In this embodiment, the orientation column records a plurality of orientations any of which the electronic device 1 may be positioned. For example, a rectangular digital photo frame may be placed with the long axis aligned vertically or alternatively placed horizontally. The function column records functions associated with the orientations. For example, as shown in the orientation function list 310 below, when the electronic device 1 is in orientation a, a music playing function is activated; when the electronic device 1 is in orientation b, a photo sharing function is activated. In other embodiments an orientation may be associated with more than one function.

### Orientation Function List

| Orientation | Function |
|---|---|
| Orientation a | Play music |
| Orientation b | Share photos |
| . . . | . . . |

The central processing unit 40 is configured for controlling the electronic device 1. The central processing unit 40 further includes a fetching module 410, a recognizing module 420, and a display control module 430. The fetching module 410 is configured for fetching signals from the induction unit 10. The recognizing module 420 is configured for recognizing the current orientation of the electronic device 1 according to the fetched signals. The display control module 430 is configured for selecting a function according to the current orientation from the orientation function list 310 and controlling the display unit 20 to display the interface that corresponds to the selected function.

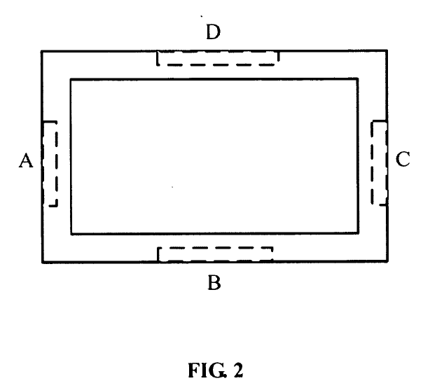

FIG. 2 is a distribution diagram of induction units of the electronic device of FIG. 1. In the exemplary embodiment, the electronic device 1 is a rectangle photo frame. Each side of the rectangle photo frame 1 has a pressure inductor. An orientation a corresponds to a pressure inductor A, an orientation b corresponds to a pressure inductor B, an orientation c corresponds to a pressure inductor C, and an orientation d corresponds to a pressure inductor D. For example, when the frame 1 is placed in orientation d, the pressure inductor D generates the inductive signals.

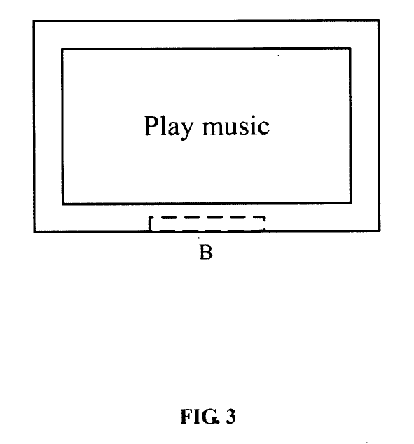

As shown in FIG. 3, the rectangle photo frame 1 is placed with the long axis in a horizontal direction. The pressure inductor B generates inductive signals and the central processing unit 40 selects a function associated with the orientation b from the orientation function list 310 according to the generated signals and controls the display unit 20 to display the corresponding interface, such as a play-music interface.

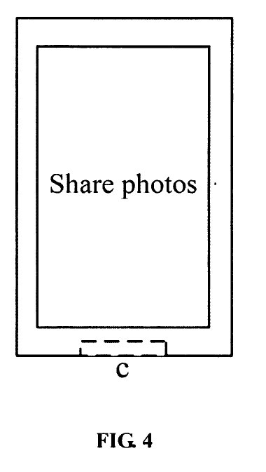

As shown in FIG. 4, the rectangle photo frame 1 is placed with the long axis in vertical direction. The pressure inductor C generates the inductive signals, and the central processing unit 40 selects a function associated with the orientation c from the orientation function list 310 according to the generated signals and controls the display unit 20 to display the corresponding interface, such as a share-photos interface.

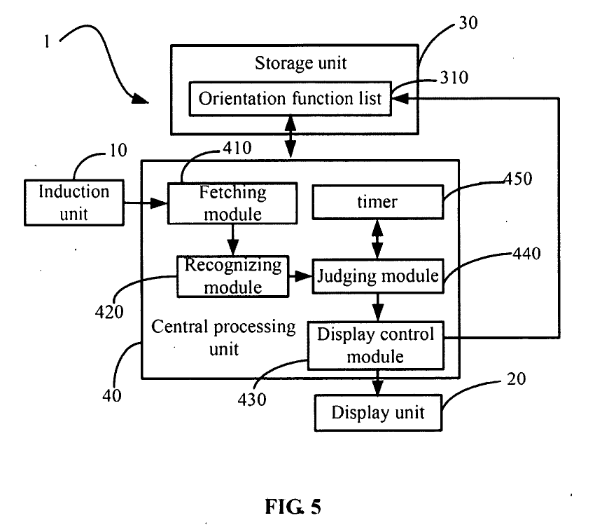

FIG. 5 is a block diagram of a hardware infrastructure of an electronic device in accordance with a second exemplary embodiment. Compared to FIG. 1, the central processing unit 40 of FIG. 5 further includes a judging module 440 and a timer 450. The judging module 440 is configured for judging whether the current orientation is different from previously fetched current orientation. If the judging module 440 judges that the current orientation is not altered, the display control module 430 controls the display unit 20 to maintain displaying, or begin displaying if at start-up, the interface associated with the current function.

When the judging module 440 judges that the orientation is altered, the timer 450 starts measuring time. The judging module 440 is further configured for judging whether an elapsed time of the timer 450 reaches a predetermined time period before the orientation is altered again. If the elapsed time reaches the predetermined time period, the display control module 430 selects a function corresponding to the altered orientation from the orientation function list 310 and controls the display unit 20 to display a corresponding interface, and the timer 450 stops measuring time. If the elapsed time does not reach the predetermined time period before the orientation is altered again, the timer 450 starts measuring time again without selecting a function. By having a predetermined time period, unwanted function changes may be avoided in response to temporary orientation changes caused perhaps, by a user carrying the electronic device 1.

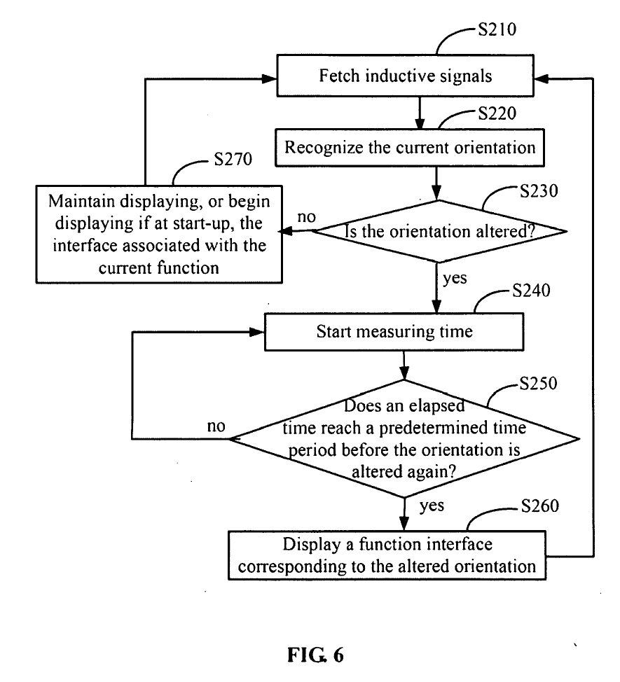

FIG. 6 is a flowchart of a method for selecting a function implemented by the electronic device of FIG. 5. In step S210, the fetching module 410 fetches the inductive signals from the induction unit 10 at real time. In step S220, the recognizing module 420 recognizes the current orientation according to the fetched signals. In step S230, the judging module 440 judges whether the orientation is altered. When the judging module 440 judges that the current orientation is not altered, in step S270, the display control module 430 controls the display unit 40 to maintain displaying, or begin displaying if at start-up, the interface associated with the current function.

When the judging module 440 judges that the orientation is altered, in step S240, the timer 450 starts measuring time. In step S250, the judging module 440 judges whether the elapsed time of the timer 450 reaches the predetermined time period before the orientation is altered again. If the elapsed time does not reach the predetermined time period before the orientation is altered again, the procedure returns to step S240 and the timer 450 starts measuring time again without selecting a function. If the judging module 440 judges that the elapsed time reaches the predetermined time period before the orientation is altered again, in step S260, the display control module 430 selects the function corresponding to the altered orientation from the orientation function list 310 and controls the display unit 20 to display the corresponding interface, and the timer 450 stops measuring time. After step S260, the process runs all the time. When the induction unit 10 generates the inductive signals, the central processing unit 40 recognizes the current orientation according to the signals.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. An electronic device comprising:
a storage unit configured for storing relationships between orientations and functions;
a display unit configured for displaying a function interface;
an induction unit configured for generating inductive signals; and
a central processing unit configured for fetching the inductive signals from the induction unit, recognizing a current orientation according to the fetched signals, and if the current orientation is altered, selecting a function corresponding to the altered orientation from the storage unit and controlling the display unit to display the corresponding interface.

2. The electronic device as recited in claim 1, wherein the induction unit is a pressure inductor, or a directional inductor.

3. The electronic device as recited in claim 1, wherein if the current orientation is not altered, the central processing unit controls the display unit to maintain displaying, or begin displaying if at start-up, the interface associated with the current function.

4. The electronic device as recited in claim 1, further comprising a timer for measuring time when the current orientation is altered.

5. The electronic device as recited in claim 4, wherein when the orientation is altered, the central processing unit further judges whether an elapsed time of the timer reaches a predetermined time period before the orientation is altered again.

6. The electronic device as recited in claim 5, wherein if the elapsed time reaches the predetermined time period before the orientation is altered again, the central processing unit selects the function corresponding to the altered orientation from the storage unit and controls the display unit to display the corresponding interface.

7. The electronic device as recited in claim 5, wherein if the elapsed time does not reach the predetermined time period before the orientation is altered again, the timer starts measuring time again without selecting a function.

8. A method for selecting a function of an electronic device, comprising
storing relationships between orientations and functions;
fetching inductive signals based on the orientation of the electronic device;
recognizing the current orientation according to the fetched signals; and
if the orientation is altered, selecting a function corresponding to the altered orientation and displaying a corresponding interface.

9. The method as recited in claim 8, further comprising:
if the orientation is not altered, maintaining displaying, or beginning displaying if at start-up, an interface associated with the current function.

10. The method as recited in claim 8, further comprising:
starting measuring time, when the orientation is altered.

11. The method as recited in claim 10, further comprising:
judging whether an elapsed time reaches a predetermined time period before the orientation is altered again.

12. The method as recited in claim 11, further comprising:
when the elapsed time reaches the predetermined time period before the orientation is altered again, selecting a function corresponding to the altered orientation and displaying a corresponding interface, and stopping measuring time.

13. The method as recited in claim 11, further comprising:
if the elapsed time does not reach the predetermined time period before the orientation is altered again, starting measuring time again without selecting a function.
